(19) United States
(12) Patent Application Publication
(10) Pub. No.: US 2004/0104655 A1
(43) Pub. Date: Jun. 3, 2004

(54) Display device

(76) Inventors: Yoshie Kodera, Chigasaki (JP); Masakazu Sagawa, Inagi (JP); Mutsumi Suzuki, Kodaira (JP); Motoyuki Miyata, Hitachi (JP); Toshiaki Kusunoki, Tokorozawa (JP); Akinori Maeda, Yokohama (JP); Hidenao Kubota, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/635,814

(22) Filed: Aug. 7, 2003

(30) Foreign Application Priority Data
Nov. 21, 2002 (JP) 2002-337364

(51) Int. Cl. H01J 1/88; H01J 1/62

(52) U.S. Cl. 313/292; 313/495

(57) ABSTRACT

The device comprises a first substrate with a plurality of electron emitters arranged in a matrix, a second substrate arranged in opposed relation to the first substrate and having a phosphor pattern formed on the surface thereof nearer to the first substrate for emitting light by receiving the electron beam from the electron emitters and a metal thin film for accelerating the electron beam, and a plurality of spacers arranged between the first and second substrates. The spacers each include first sheet-form support members and second sheet-form support members extending in a direction at right angles to the first sheet-form support members. The first sheet-form support members and the second sheet-form support members are coupled or combined with each other to form spaces with a rectangular section parallel to the first or second substrate.

### BACKGROUND OF THE INVENTION

The present invention relates to a field emission display (hereinafter referred to as FED) making up a flat panel display device having a hermetic container accommodating an electron source with electron emitters constituted of cold cathode elements arranged in matrix, or in particular to an improvement of a spacer for forming a gap between a pair of opposed substrates.

In recent years, FED has been closely watched as a flat panel display device of emissive type low in power consumption and having a brightness and contrast equivalent to those of the cathode ray tube. The well-known electron emitters include an emitter of surface conduction type (hereinafter referred to as SED type), an emitter of field emission type (hereinafter referred to as FE type) and an emitter of metal insulator metal type (hereinafter referred to as MIM type). The Spindt-type emitter fabricated mainly of a metal such Mo or a semiconductor material such as Si and the CNT-type emitter using CNT (carbon nanotube) as an electron source are also known as the electron emitters of FE type. An emitter of SED type is disclosed in JP-A-2000-164129, and an emitter of MIM type is disclosed in JP-A-2001-101965 and JP-A-2001-243901.

The FED comprises a first substrate (back-side substrate) formed with electron emitters, a second substrate (display-side substrate) arranged in opposed relation to the first substrate and adapted to emit light in response to the electron beams emitted from the electron emitters, and a spacer for supporting the first and second substrates and forming a gap between the two substrates. A spacer is disclosed in JP-A-2000-164129, JP-A-2002-157959 and “SID 97 Digest (1997 Society for Information Display International Symposium Digest of Technical Papers Vol. 28, (1997)), pp. 52-55”.

The spacer is charged by the action of electrons released from the electron emitters. As a result, the trajectory of the electrons released from the electron emitters is curved and the image is distorted in the neighborhood of the spacer. In order to prevent this phenomenon, JP-A-57-118355 and JP-A-61-124031 disclose a method in which the surface of the spacer is formed with a tin oxide film of high resistance or a conductive film made up of a metal film or a mixed crystal film of tin oxide and indium oxide thereby to cause a very small current flow on the spacer surface.

### SUMMARY OF THE INVENTION

JP-A-2000-164129 and “SID 97 Digest (1997 Society for Information Display International Symposium Digest of Technical Papers Vol. 28, (1997)), pp. 52-55” fail to refer to a method of mounting the spacer. The spacer described in these references is as thin as 0.2 mm and therefore cannot hardly stand by itself on the substrate. Thus, it is difficult and cumbersome to mount the spacer in vertical position on the substrate formed with the electron emitters. The labor consumed for mounting the spacer may pose a serious problem in view of the possible increase in screen size in the future.

An example of a configuration of FED having a large screen will be explained with reference to FIG. 15. FIG. 15 shows an example of (a part of) an array of phosphor elements of a flat panel display device having a display range of 30 inches, 1280×720 pixels (each pixel including a set of R, G, B color subpixels) and an aspect ratio of 16:9. In FIG. 15, the phosphor elements 111R, 111G, 111B are arranged at pitches of 0.173 mm along Y direction with black matrices 120a each 0.05 mm wide therebetween. Also, the phosphor elements 111R, 111G, 111B are separated from each other along X direction by black matrices 120b about 0.1 mm wide. In order to prevent the spacer from affecting the image, each spacer is required to be arranged within a corresponding black matrix and the width of the spacer is required to be not more than 100 μm, i.e. the width of the wider black matrix 120b. Further, taking the mounting error, etc. of the spacer into consideration, the thickness of each spacer is required to be about 90 μm. Assuming that the height of the spacer is 3 mm, for example, the aspect ratio is 33. As compared with the prior art, therefore, it is even more difficult to insert the spacers individually between the display-side substrate 110 and the back-side substrate 10.

The FED uses the light emission of the phosphor elements excited by the electron beams. When it is operated with an acceleration voltage of 100 V applied to the phosphor elements, a current density about ten hundred times higher than the CRT is required due to the lower acceleration voltage. This high current density causes the brightness saturation of the phosphor elements and the deteriorated electron beam radiation, and therefore the acceleration voltage for accelerating the electron beams is required to be increased to 5 KV or higher. In order to assure electrical insulation of the acceleration voltage, on the other hand, the gap between the substrates is required to be as large as 1 to 3 mm. Thus, a spacer with a high aspect ratio is required which is as wide as about 90 μm and as tall as 1 to 3 mm. Specifically, even in the case where the gap between the substrates is increased to prevent the deterioration of the phosphor elements, the problem is still posed for mounting the spacer as in the case of the flat panel display device having a large screen described above.

A method of mounting a spacer is disclosed in FIG. 6 of JP-A-2002-157959, in which the length of the spacer is increased to extend outside the image area (acceleration field applied area), and this spacer is inserted fixedly in a support member having a channel-shaped groove formed outside the image area. In the case where this method is applied to the large screen of 30 inches having an aspect ratio of 16:9 described above, for example, it means the insertion of a thin glass plate with a spacer 90 μm thick, 66.4 mm or longer and 2 to 3 mm tall in the support member. As a result, the thin glass plate is displaced requiring a very great labor. Further, the fact that the atmospheric pressure is loaded on the beam, a buckling deformation is liable to occur.

As described above, it is a great problem how to assemble a spacer substantially upright between the back-side substrate constituting an electron emission source and the display-side substrate formed with the emissive phosphor elements when arranging the two substrates in opposed relation to each other. The prior art described above fail to give full consideration to the configuration of a spacer applicable to a flat panel display device having a large screen size or a larger gap between the substrates.

JP-A-57-118355 and JP-A-61-124031 disclose a configuration for preventing the deterioration of the directionality of the electron beams caused by the charge stored on the spacer surface. Nevertheless, the charge transfer through the glass substrate constituting the spacer base has not been taken specifically into consideration.

This invention has been developed in view of the problem mentioned above and the object thereof is to provide a flat panel display device comprising a spacer easily mountable on the substrates.

In order to achieve this object, according to this invention, there is provided a flat panel display device wherein a spacer includes a plurality of first sheet-form support members extending in a predetermined direction and a plurality of second sheet-form support members extending in a direction different from the predetermined direction, and wherein the first and second sheet-form support members are joined with each other thereby to form spaces each containing at least one of the plurality of the electron emitters.

As an example, the first and second sheet-form support members are arranged and joined at right angles with each other thereby to form a plurality of spaces each having a rectangular cross section parallel to the first or second substrate. The space formed by the first and second sheet-form support members may be triangular instead of rectangular.

This configuration makes possible a self-standing spacer (which can maintain by itself the position perpendicular to the substrate surfaces) and facilitates the mounting thereof. Also, the resulting ladder or cellular structure of the spacers improves the strength. Further, a self-standing spacer of an arbitrary size can be realized by increasing the number of the sheet-form support members making up the spacer. Consequently, the flat panel display device, even with a smaller number of the spacers arranged therein, can stand the atmospheric pressure.

Also, a plurality of electron emitters are contained in each of the rectangular spaces formed by the sheet-form support members. Specifically, one or a plurality of units each including three electron emitters corresponding to a set of R, G, B color sub-pixels are contained in each space. The three electron emitters making up a unit corresponding to each set of R, G, B color sub-pixels makes it difficult to cause the color drift in the case where the spacers have an effect (such as the charge) on the image formed by the light emission of the phosphor elements.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view showing a self-standing spacer according to an embodiment of the invention.

FIGS. 2A to 2C are diagrams showing the steps of assembling a self-standing spacer.

FIG. 3 is a sectional view taken in line D-D′ in FIG. 1 showing a sheet-form support member 301b.

FIG. 4 is a diagram showing the arrangement of a self-standing spacer according to an embodiment.

FIG. 5 is a diagram showing the relation between phosphor elements and black matrices.

FIG. 6 is a diagram showing a self-standing spacer according to a second embodiment.

FIG. 7 is a diagram showing a self-standing spacer according to a third embodiment.

FIG. 8 is a diagram showing a T-shaped self-standing spacer.

FIG. 9 is a diagram showing an L-shaped self-standing spacer.

FIGS. 10A and 10B are diagrams showing a metal spacer according to an embodiment.

FIGS. 11A and 11B show sectional structures of the MIM-type electron emitter.

FIGS. 12A to 12C are diagrams showing electron emitters arranged in matrix on the back-side substrate of a flat panel display device.

FIGS. 13A to 13C are schematic diagrams showing a configuration of the display-side substrate arranged in opposed relation to the back-side substrate.

FIGS. 14A and 14B are sectional views of a flat panel display device.

FIG. 15 is a diagram showing an example of arrangement of the phosphor elements of a flat panel display device having a display range of 30 inches, 1280×720 pixels (each pixel including a set of R, G, B color sub-pixels) and an aspect ratio of 16:9.

FIG. 16 is a diagram showing relative positions of a self-standing spacer and phosphor elements arranged in a delta.

FIG. 17 is a diagram showing a self-standing spacer according to another embodiment.

FIG. 18 is a diagram showing a self-standing spacer according to still another embodiment.

### DESCRIPTION OF THE PREFERRED EMBODIMENTS

An embodiment of the invention will be explained below with reference to the accompanying drawings. First, a FED electron emitter according to the invention and an example of the structure of a flat panel display device comprising the particular electron emitter will be explained taking the MIM-type electron emitter as an example. Though not specifically described, the invention is similarly applicable to FED of SED type, FE type and CNT type with equal effect.

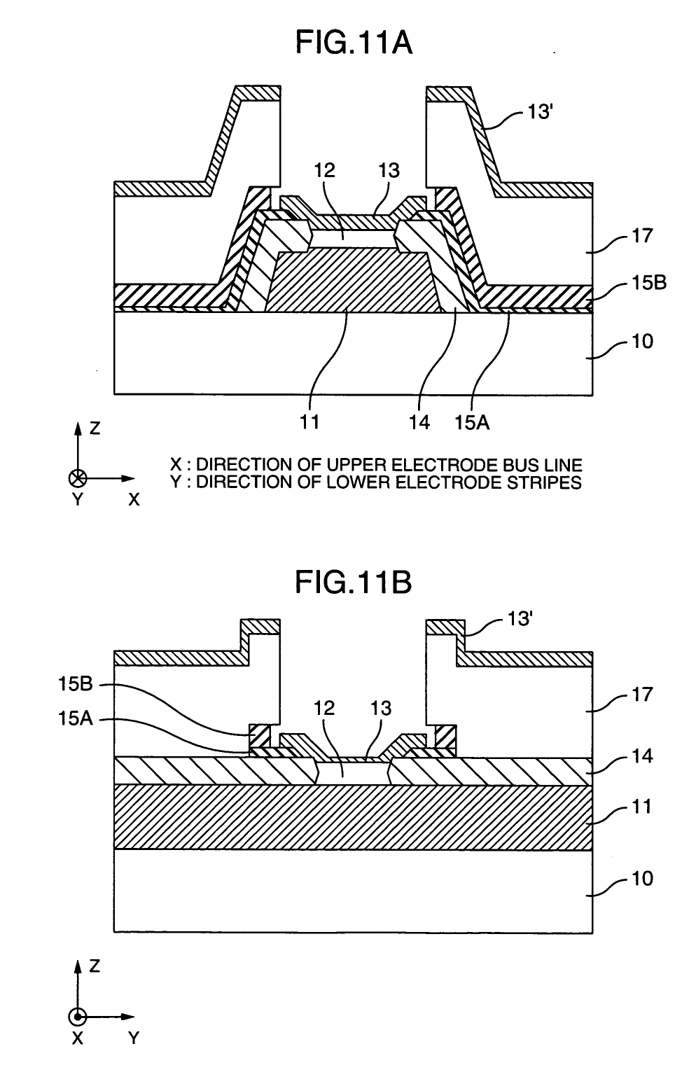

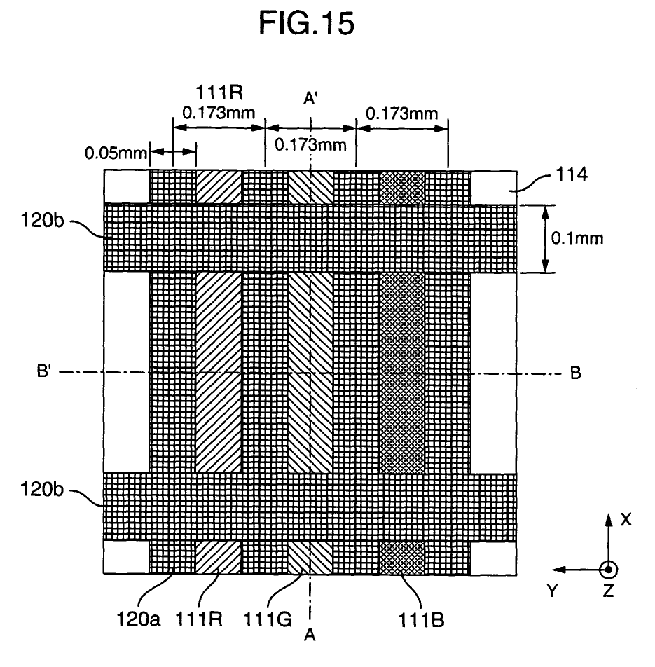

FIGS. 11A and 11B are diagrams showing the sectional structure of the MIM-type electron emitter. FIG. 11A is a sectional view taken in the direction perpendicular to stripes of bottom electrodes, and FIG. 11B a sectional view taken in the direction parallel to the stripes of the bottom electrode. In FIGS. 11A and 11B, bottom electrodes 11 of Al or Al—Nd alloy 300 nm thick are formed in stripes in the direction Y along the thickness perpendicular to the page of FIG. 11A on a substrate 10 of an insulating material such as glass (in the vertical direction Z parallel to the page). The bottom electrode 11 is formed thereon with a protective insulating layer 14 (140 nm thick, for example) for limiting or defining an electron emitting portion while at the same time preventing the electric field from being concentrated at the edges of the bottom electrode 11 and a tunnel insulating layer 12 (10 nm thick, for example). The protective insulating layers 14 are formed thereon, except for the portion corresponding to the electron emitting portion, with a top electrode bus line 15 of a double layer structure including a top electrode lower bus line layer 15A and a top electrode upper bus line layer 15B in stripes in the direction at right angles to the bottom electrode 11 (the direction X along the width of the page in FIG. 15A). The top electrode lower bus line layer 15A is formed of a metal film of W or Mo about 10 nm thick having a high melting point and a high adhesion with the substrate 10 and the protective insulating layer 14, while the top electrode upper bus line layer 15B is formed of an Al—Nd film 200 nm thick providing a low-resistance power feeder to a top electrode 13 (described later). The metal film of the top electrode lower bus line layer 15A is preferably as thin as possible to prevent the disconnection of the top electrode 13. To protect the electron emitters, the top electrode bus line 15, the protective insulating layer 14 and the substrate 10 are formed thereon, except for the electron emitting portion, with a passivation film 17 providing an insulating film of glass such as SiO₂, phosphosilicate glass or borosilicate glass, Si₃N₄, Al₂O₃ or polyimide. In the case of Si₃N₄, the thickness is about 0.3 to 1 μm. The top electrode 13 providing an electron emitting portion is formed on the insulating layer 12 by sputtering, for example, as a metal film of three layers including a highly heat-resistant lower layer of Ir, an intermediate layer of Pt and an upper layer of Au having a high electron emission efficiency. At the same time, the three metal layers 13′ making up the top electrode 13 are formed by sputtering also on the upper surface of the passivation film 17. As shown in FIGS. 11A and 11B, however, the top electrode upper bus line layer 15B is retreated inward of the passivation film 17 acting like an eaves. Thus, the metal film 13′ on the passivation film 17 and the top electrode 13 are separated from each other.

In the case where a predetermined voltage Vd is applied in vacuum between the top electrode 13 and the bottom electrode 11 of the MIM-type electron emitter having this configuration, the electrons at or near the Fermi level in the bottom electrode 11 are passed through the barrier by the tunnel phenomenon and injected into the conduction band of the top electrode 13 and the insulating layer 12 thereby to form hot electrons. Of these hot electrons, those having an energy larger than the work function φ of the top electrode 13 are released into the vacuum.

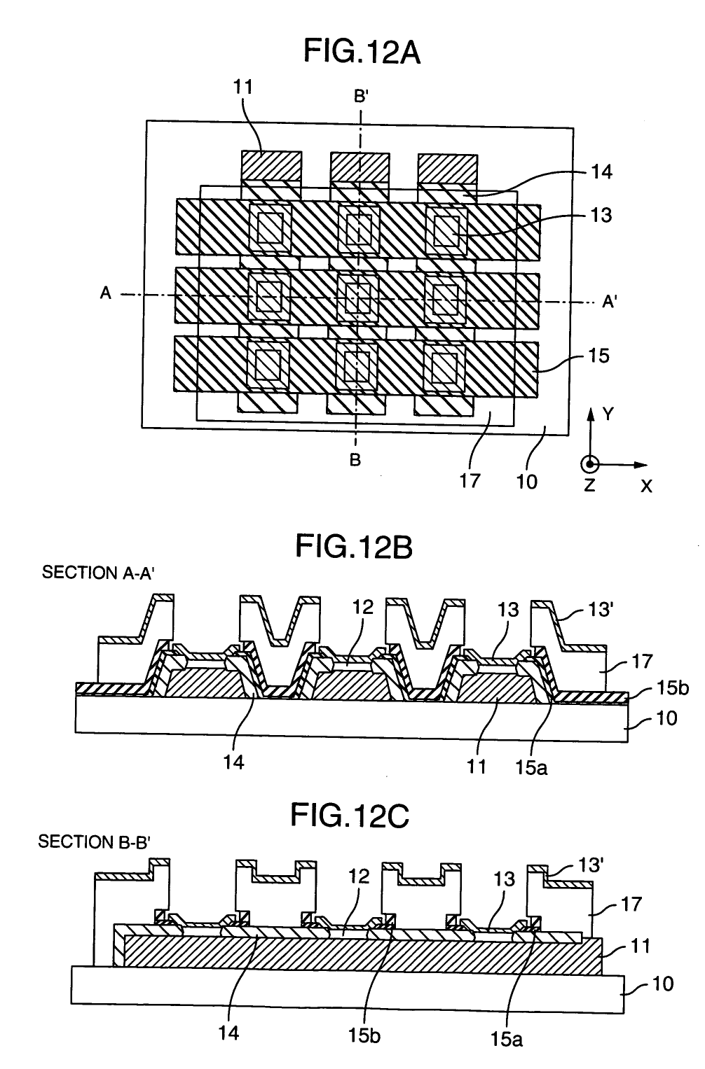

FIGS. 12A to 12C show an array of the aforementioned electron emitters formed in a matrix on the back-side substrate 10 of the flat panel display device. In FIGS. 12A to 12C, those component parts identical to the corresponding component parts in FIGS. 11A and 11B are designated by the same reference numerals, respectively, and will not be described again. For simplification of the explanation, 3×3 electron emitters are depicted. Each electron emitter corresponds to one color sub-pixel. A trio set of red (R), green (G), blue (B) color sub-pixels corresponds to one pixel. In FIG. 12A is a plan view showing electron emitters arranged in a matrix, FIG. 12B a sectional view taken in line A-A′ along direction X in FIG. 12A, and FIG. 12C a sectional view taken in line B-B′ along direction Y. The MIM-type electron emitters described above are formed in a matrix of 3×3 on the back-side substrate 10. The bottom electrodes 11 in stripes are arranged in parallel to each other in direction Y, while the top electrode bus lines 15 are arranged in parallel to direction X perpendicular to direction Y. The electron emitting portion, i.e. the top electrode 13 is arranged at each crossing point between the bottom electrode 11 and the top electrode bus line 15.

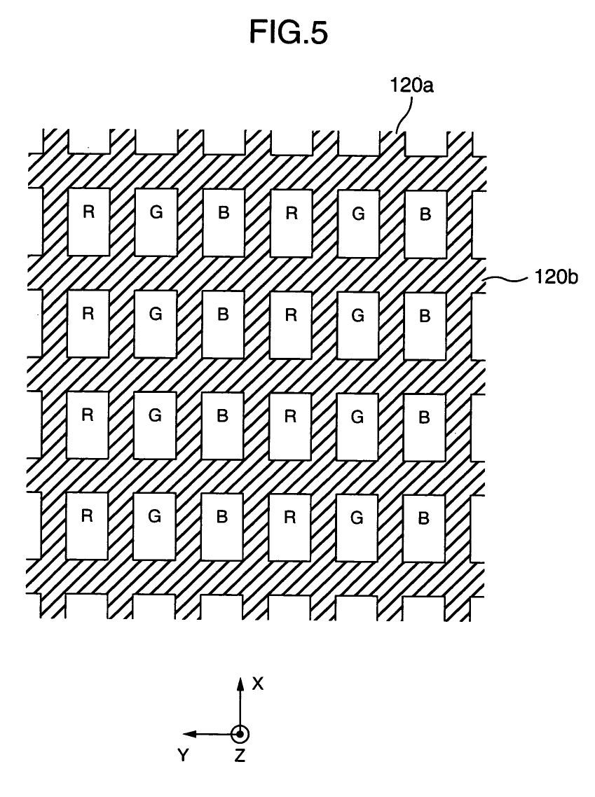

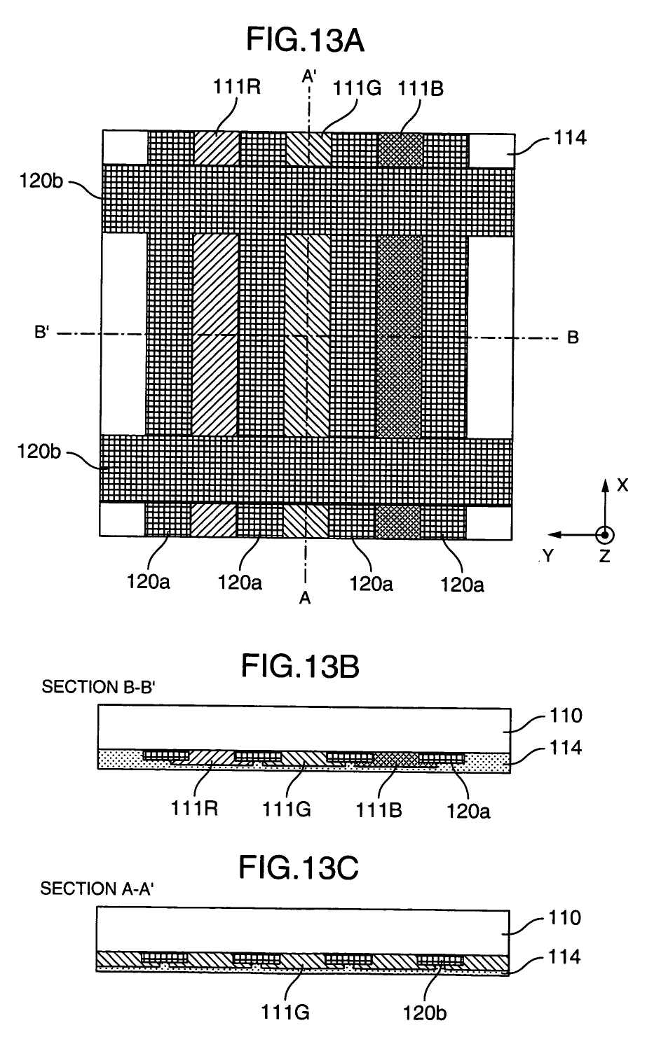

FIGS. 13A to 13C are schematic diagrams showing a configuration of the display-side substrate arranged in opposed relation to the back-side substrate. FIG. 13A is a plan view of the display-side substrate, FIG. 13B a sectional view taken in line B-B′ in direction Y, and FIG. 13C a sectional view taken in line A-A′ in direction X. FIG. 5 is a diagram showing the relation between the black matrices and the phosphor elements formed on the display-side substrate. In FIGS. 13A to 13C, the inner surface of the substrate 110 providing the display-side substrate is coated with stripes of the phosphor elements 111R, 111G, 111B of red (R), green (G) and blue (B), respectively, like the phosphor elements of the CRT, for example, as shown in FIG. 5, in parallel to the top electrode bus lines 15 with the black matrices 120a arranged therebetween. The black matrices 120b are further arranged to isolate the pixels from each other as shown in FIG. 5. The black matrices 120a, 120b are for improving the contrast. Generally, the width of the black matrix 120b is larger than that of the black matrix 120a. The phosphor element 111 is formed thereon with a film of nitrocellulose or the like (not shown) and a metal back (acceleration electrode) 114 of Al, for example, to accelerate the hot electrons from the electron emitters toward the phosphor elements. The electron beams (not shown) providing the electrons from the electron emitters which are accelerated by the acceleration voltage (not shown, 3 to 6 KV, for example) applied to the metal back 114 are impinged on the corresponding phosphor elements 111R, 111G, 111R, respectively, and cause them to emit the light of the respective colors.

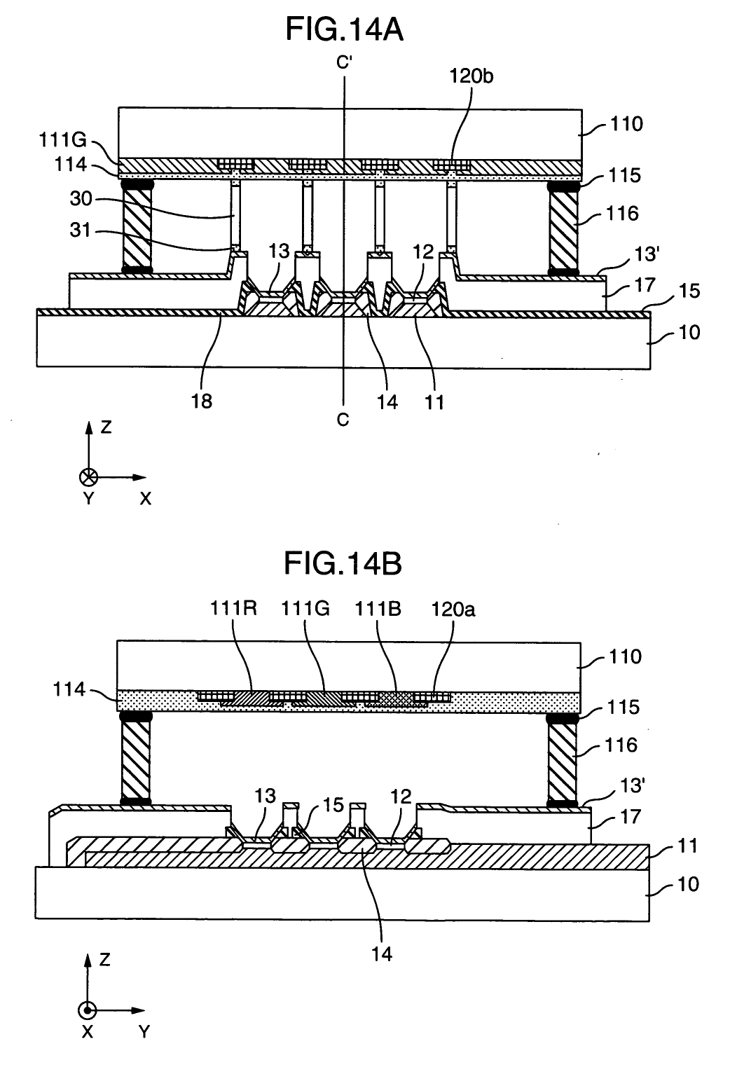

FIGS. 14A and 14B are sectional views of a flat panel display device, in which FIG. 14A shows a sectional view taken along the X-Z plane of the flat panel display device, and FIG. 14B a sectional view taken in line C-C′ along the Y-Z plane in direction Z in FIG. 14A. To facilitate the understanding, these diagrams are shown in exaggerated form. In FIGS. 14A and 14B, the display-side substrate 110 and the back-side substrate 10 configured like in FIGS. 12 and 13 are arranged in opposed relation to each other. The display panel is sealed by heat treatment of a surrounding frame 116 at a temperature of about 400° C. using the frit glass 115 through spacers 30. The display panel thus sealed is pumped out by exhausting the air to the vacuum of about 10⁻⁵ to 10⁻⁷ torr.

As described above, in the flat panel display device using the electron emitters, the pressure in the display panel is reduced with the electron emitters arranged in a matrix. Means is necessary, therefore, for preventing the deformation or breakage of the display-side substrate 110 and the back-side substrate 10 due to the pressure difference between the interior and the exterior of the display panel. In view of this, as shown in FIGS. 14A and 14B, spacers 30 making up structural support members each formed of a comparatively thin glass plate of an insulating material to stand the atmospheric pressure are inserted between the display-side substrate 110 and the back-side substrate 10. The spacers 30, as shown in FIG. 14A, for example, are arranged on the passivation film 17 on the top electrode bus lines 15 in the gap between the bottom electrodes 11 in parallel to the bottom electrodes 11 in such a manner as not to prevent the release of electrons. Also, in order that the light emission of the phosphor elements 111 may not be prevented by the spacers 30, each spacer 30 is arranged within the width of the black matrix 120b thereunder. The provision of the spacers on the wide black matrix 120b is to increase the strength by increasing the thickness thereof as far as possible on the one hand and to facilitate the mounting at the same time.

On the other hand, the spacers are charged by the action of the electrons from the electron emitters. In the neighborhood of each spacer, therefore, the trajectory of the electrons released from the back-side substrate 10 is curved and the image is deformed. In order to prevent this phenomenon, the surface of each spacer is formed with a conductive film of high-resistance tin oxide or a conductive thin film of a metal or a mixed crystal of tin oxide and indium oxide to allow a very small current to flow along the spacer surface. For this purpose, each spacer 30 is electrically and mechanically connected to the metal back 114 and the metal film 13′ on the passivation film 17 by a conductive joint member 31. The conductive joint member is made of, for example, a conductive adhesive, conductive metal particles or frit glass with a conductive filler added thereto. An end surface not shown of the metal film 13′ is connected to the grounding circuit of the flat panel display device.

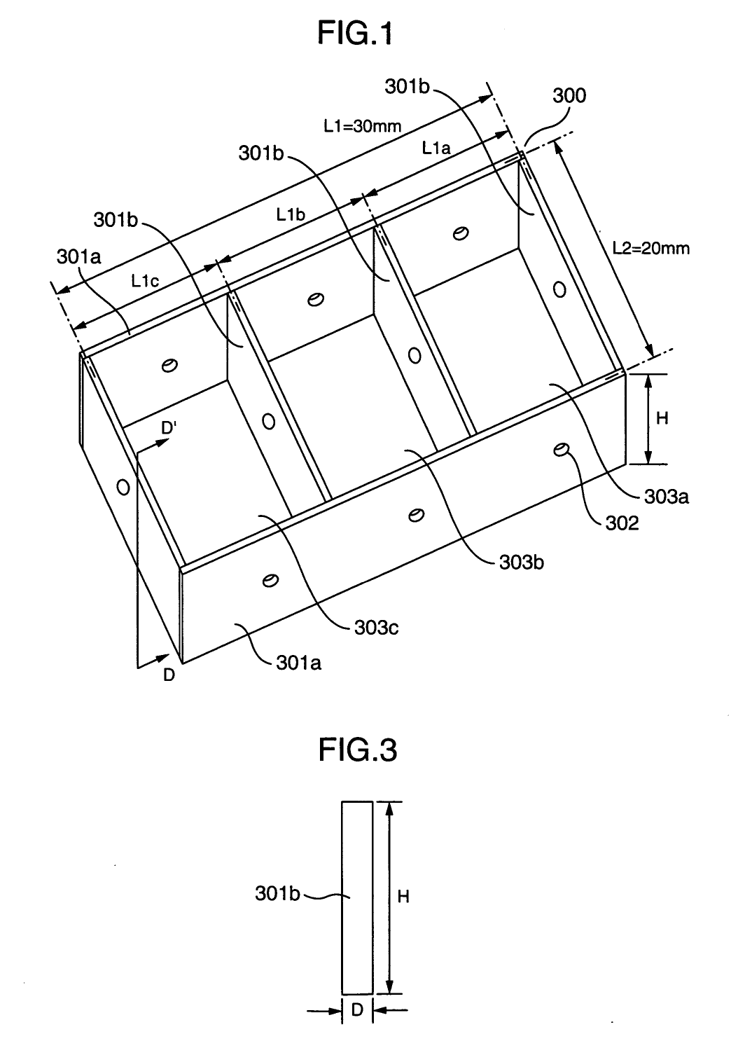

Next, a spacer 30 used for the FED according to an embodiment described above will be explained with reference to FIG. 1. In FIG. 1, the self-standing spacer 300 includes a plurality of first sheet-form support members 301a (two in FIG. 1, each having the length L1 of about 30 mm) of glass of an insulating material and a plurality of second sheet-form support members 301b (four in FIG. 1, each having the length L2 of about 20 mm) also formed of glass. The length of the first sheet-form support members 301a is at right angles to the second sheet-form support members 301b. In the case where the first sheet-form support members 301a are formed to extend along the vertical direction on the page, for example, the second sheet-form support members 301b are formed to extend along the horizontal direction on the page. As shown in FIG. 1, the first and second sheet-form support members 301a, 301b are coupled or combined with each other to form three spaces 303a, 303b, 303c each having a rectangular section parallel to the back-side substrate or the display-side substrate. As a result, a self-standing ladder-type support member is configured. In the case under consideration, the spaces 303a, 303b, 303c are assumed to have the same area and the same shape. Also, in order to equalize the rectangular areas of the spaces 303, each sheet-form support member 301a in FIG. 1 is divided into three equal portions (length L1a=L1b=L1c) along the length thereof by the sheet-form support members 301b. Nevertheless, the invention is not limited to this structure.

This configuration makes possible a self-standing spacer 300. Also, the ladder-type structure (or a grid-type structure as a whole) increases the strength of the spacer 30. Further, a self-standing spacer of an arbitrary scale and size can be formed by increasing the length of the sheet-form support members 301a and the number of the sheet-form support members 301b. Thus, the number of the spacers can be reduced.

The self-standing spacer 300 providing a ladder-type self-standing support structure can be assembled in advance using a plurality of sheet-form support members, and therefore, unlike in the prior art, can be fabricated in different steps from those of the flat panel display device, thereby making it possible to reduce the assembly time of the flat panel display device. Also, a great number of spacers 300 can be prepared in keeping with the production requirement. By supplying a multiplicity of self-standing spacers 300 assembled independently of the steps of assembling a flat panel display device, the number of spacers can be reduced while at the same time facilitating the installation of the self-standing spacers at the desired position, thereby making it possible to shorten the spacer mounting time.

In the case where the first and second sheet-form support members 301a, 301b are made of glass, the glass preferably contains SiO₂ as a main component having a strain point of not lower than 400° C. The flat panel display device, after mounting the spacers thereon, is hermetically sealed to prevent the deformation in the subsequent heat treatment process conducted at about 400° C.

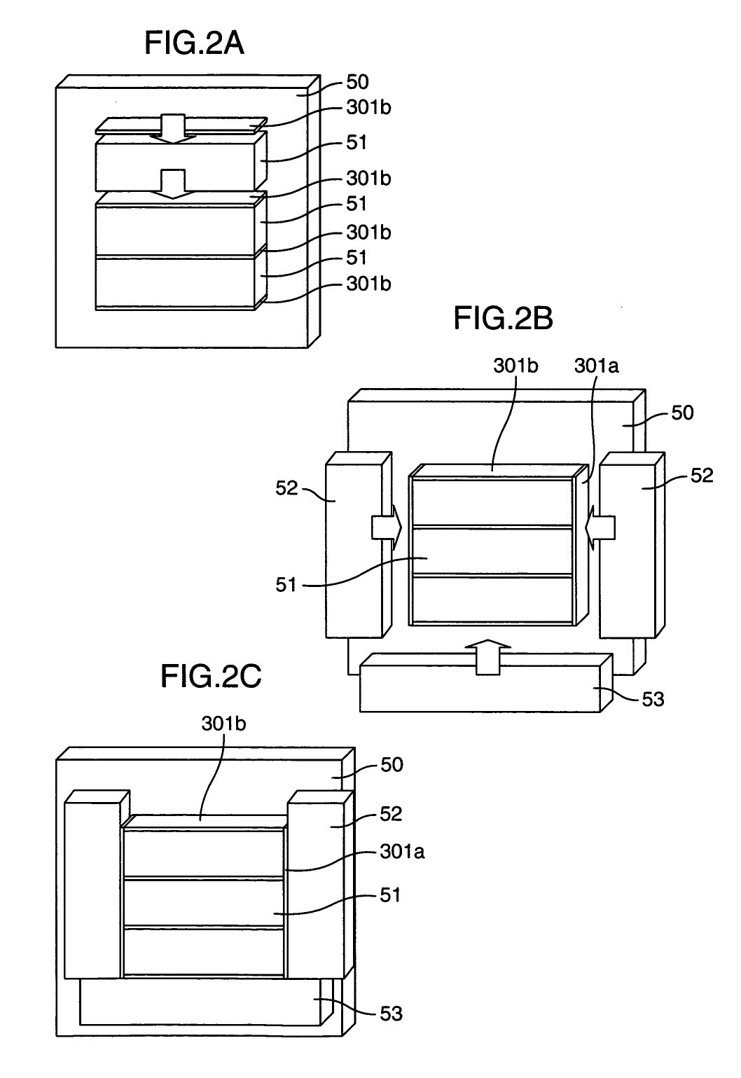

In FIGS. 2A to 2C show the assembly steps. First, as shown in FIG. 2A, reference blocks 51 are stacked on the base 50 having a high flatness in vertical direction parallel to the page to help assemble highly durable parallelepipedic ceramic members having the same length and height as the sheet-form support members 301b with high flatness and parallelism. A sheet-form support member 301b is inserted between each adjacent ones of the reference blocks 51. The upper surface of the uppermost reference block 51 and the lower surface of the bottom reference block 51 are each arranged in close contact with the sheet-form support member 301b, so that the sheet-form support members 301b may be arranged in parallel to each other at an interval equivalent to the thickness of the reference block 51. Next, as shown in FIG. 2B, the sheet-form support members 301a are brought into close contact with reference blocks 52 from the lateral direction in the page. After that, a reference block 53 is pressed against the sheet-form support members from the lower part of the page so that the lower surface of the ladder-type self-standing support structure is placed in position. Thus, the ladder-type self-standing spacer 300 is completely assembled as shown in FIG. 2C.

After that, the sheet-form support members 301a, 301b making up the component members of the ladder-type self-standing support structure assembled with the reference blocks in the manner described above are integrated with each other. The first step for this integration is to coat a dielectric material such as frit glass on the ladder-type self-standing support structure. Then, the dielectric material is molten by heat treatment at the temperature as high as 300 to 450° C. In another method of integrating the sheet-form support members 301a, 301b, the sheet-form support members 301a, 301b are coated with polysilazane, a precursor of the liquefied glass with inorganic polymer as a starting material having a nitrogen-silicon combination as a basic unit, and coupled to each other integrally by a silica film obtained by baking at high temperatures of not lower than 120° C. in the atmosphere. After integration, the reference blocks 51 to 53 are removed. In this way, the self-standing spacer 300 making up the ladder-type self-standing support structure can be assembled.

FIG. 3 is a sectional view taken in line D-D′ of the sheet-form support member 301b shown in FIG. 1. The height H of the sheet-form support member 301b is in the range of 1 to 3 mm. As described above by reference to the summary of the invention, the acceleration voltage of not lower than 5 KV is required to suppress the deterioration of electron beam radiation or the brightness saturation of the phosphor elements. Taking the electrical insulation due to the acceleration voltage into consideration, the height H of the sheet-form support member which is the spatial distance between the display-side substrate and the back-side substrate is preferably in the range of 1 to 3 mm. Also, the thickness D of the sheet-form support member 301b is required to be not more than the width of the black matrix of the phosphor film formed on the display-side substrate. According to the invention, as apparent from FIG. 1, the spacer is in the form of ladder to assure the self-standing feature, and the sheet-form support members making up the spacer are required to be arranged on the narrow black matrix 120a as well as on the wide black matrix 120b. In the 30-inch flat panel display device, as understood from FIG. 15, the width of the black matrix 120a is 50 μm, and therefore the thickness of the spacer is desirably 30 to 50 μm or most desirably 40 μm. Thus, the aspect ratio (H/D) of the sheet-form support member is as high as 20 to 100. Of course, the thickness of the sheet-form support members arranged on the wide black matrix 120b is of course not limited to this value but can be larger.

In FIG. 1, the holes 302 formed in the first and second sheet-form support members 301a, 301b are through holes having a diameter of 10 to 50 μm formed by machining means such as 266-nm laser substantially at the central portion of each sheet-form support member. The through holes 302 are intended not to hermetically seal the internal space of the self-standing spacer 300 defined by the display-side substrate and the back-side substrate and thus to permit the pressure of the particular internal space to be reduced when reducing the pressure by exhausting the gas from the flat panel display device. The size of the holes 302 can of course be increased as long as the required strength can be maintained. In FIG. 1, the self-standing spacer 300 is partitioned into three spaces 303a, 303b, 303c having an equal rectangular area defined by the wall surfaces of the sheet-form support members 301a, 301b. One hole is formed in each wall surface of the sheet-form support members defining each space 303. Nevertheless, the invention is not limited to this structure, but it is apparent that at least one space having a rectangular area is surrounded by the wall surfaces of the sheet-form support members and at least one hole can be formed in each wall surface of the sheet-form support members.

A very small current is required to flow in the spacer to prevent charging. After assembling the self-standing spacer 300 as shown in FIG. 1, therefore, a liquid containing the fine particles of a metal oxide containing at least one of tin, titanium and indium such as what is called ITO (indium tin oxide) is coated by spray or dipping thereby to form a high-resistance conductive film (surface resistance of 10⁵ to 10¹² Ω/□ (i.e., Ω/square)) on the surface of the self-standing spacer 300. The lower limit of the surface resistance value is determined from the viewpoint of power consumption, and the upper limit thereof from the anti-charge effect. Thus, the surface resistance value is preferably in the range of 10⁵ to 10¹² Ω/□. A method of forming the conductive film includes, for example, the sol-gel process, the sputtering method or the CVD (chemical vapor deposition) process.

As an alternative, the sheet-form support members 301a, 301b may of course be formed with a conductive film of a metal oxide including at least one of tin, titanium and indium such as indium tin oxide (ITO), followed by assembling the self-standing spacer 300 making up a ladder-type self-standing support structure, thereby omitting the step of forming a conductive film after assemblage. In this case, the sheet-form support members 301a, 301b are integrated preferably using the conductive frit glass mixed with a conductive filler or a metal conductive material as a conductive jointing material. A conductive adhesive may of course be used as an alternative.

As described above, a conductive film is formed on the surface of the self-standing spacer 300 to give conductivity to the self-standing spacer 300. As an alternative, conductive fine particles are contained in the glass constituting the base of the sheet-form support members 301a, 301b to secure the surface resistance of 10⁵ to 10¹² Ω/□ as described above. The present inventors could produce, by the normal roll extrusion process, a molten glass material containing 0.1 to 20 weight % of metal particulates or precious metal particulates (average particle size of about 2 to 8 μm) of Pt, Ag, Au, Cr or the like not molten at the glass melting temperature and hardly oxidated by heat, in the glass base forming the sheet-form support members 301a, 301b.

In place of the metal particulates described above, cobalt oxide, niobium oxide, titanium oxide, tin oxide, iron oxide, vanadium oxide or the like is dispersed and metal ions (transition metal ions) of Co, Nb, Ti, Sn, Fe, V or the like thus set free may be used to give conductivity. As another alternative, a semiconductor can be used which comprises a metal oxide such as indium oxide, tin oxide or titanium oxide doped with impurities. As compared with the process of forming a conductive film on the surface of the sheet-form support members, the process of containing metal particulates in the glass base of the sheet-form support members 301a, 301b to attain a predetermined surface resistance value is advantageously not easily damaged by flaws or the like. The sheet resistance value measurable as a surface resistance value can be determined in association with the acceleration voltage.

Examples of the glass material of the sheet-form support members 301a, 301b include soda lime glass and borosilicate glass. In the self-standing spacer according to the invention, however, the sheet-form support members are arranged also in the direction parallel to the top electrode bus line. Therefore, the spacer is so thin that a thin spacer material high in strength is required. In order to secure a thin spacer of high strength and hard to crack, it is preferable to use alumino silicate glass or alumino borosilicate glass containing at least selected one of rare earth elements including Sc, Y, Pr, Nd, Pm, Eu, Gd, Tb, Dy, Ho, Er, Tm, Yb and Lu disclosed in JP-A-10-83531 already filed by the present inventors.

The chemically strengthened glass is high in hardness but liable to develop the desorption of alkali elements at high temperatures, and the conductive film of the spacer is liable to be damaged by the alkali elements desorped undesirably during the heat treatment (400 to 500° C.) in the steps of gas emission or frit glass sealing for matching the display-side substrate and the back-side substrate to each other. Also, the crystallized glass, though high in hardness, is undesirable as it is disadvantageously expensive and fragile. In contrast, the glass containing rare earth elements, which is neither chemically strengthened nor crystallized to improve the strength, can be advantageously used to produce the spacer at low cost.

As disclosed by the present inventors in JP-A-10-83531, the amount of the rare earth elements that can be molten into the glass tissue having a mesh structure has its own upper limit (solution limit). In the case where a rare earth element of an amount exceeding this upper limit is added, the excess element is deposited in the parent glass phase as a crystal phase or an amorphous phase. The particles composed of this crystal phase or amorphous phase are called fine particles or particulates. The particulates dispersed in the parent glass phase functions to suppress the deformation and breakage of the parent glass phase under a stress, and therefore increases the strength. In this case, the particulates have the higher effect of increasing the strength if dispersed uniformly in the form of crystal.

In order to improve the strength, as obvious from Table 1 in JP-A-10-83531, the glass is preferably configured of, by oxide weight %, SiO₂ of 40 to 80%, B₂O₃ of 0 to 20%, Al₂O₃ of 0 to 20%, alkali metal oxide R₂O of 0 to 20%, alkali earth metal oxide R′O of 0 to 20% and the rare earth element oxide Ln₂O₃ of 0 to 20%. This configuration can improve the strength as compared with the glass containing SiO₂ as a main component (Vicker's microhardness of 615, corresponding to the sample No. 1 in Table 1 of JP-A-10-83531).

As apparent from FIG. 1 showing the change of Vicker's microhardness versus the added amount of Er₂O₃, Al₂O₃, Si₂O₄ shown in FIG. 1 of the aforementioned Japanese Patent Publication, an increased amount of Er₂O₃ added increases the hardness. With more than 30% by weight, however, the material dust is left in the glass at the time of melting the glass, and therefore it is undesirably difficult to secure glass of uniform quality. Taking the surface roughness indicated in Table 7 of the aforementioned patent publication into consideration, the content of the rare earth element oxide is preferably not more than 20 weight %.

Considering the improved strength into consideration, on the other hand, any of the rare earth elements nearer to heavy elements including Gd, Tb, Dy, Ho, Er, Tm, Yb and Lu is preferably contained, as apparent from Table 5 of the aforementioned publication. For the oxide weight ratio of 5% or more, at least the hardness (Vicker's microhardness Hv 670) of the chemically strengthened glass can be obtained.

From the viewpoint of strength improvement as described above, in order to secure the hardness not less than that of the chemically strengthened glass, it is seen from Table 1 of JP-A-10-83531 that the composition including, by oxide weight ratio, SiO₂ of 50 to 80%, B₂O₃ of 5 to 12%, Al₂O₃ of 1 to 17%, alkali metal oxide R₂O of 7 to 15%, and rare earth element oxide Ln₂O₃ of 5 to 20% is especially preferable.

Generally, the higher the hardness, the larger the modulus of elasticity (Young's modulus), with the result that the deformation against stress is smaller, as well known. In the case where the hardness is increased by containing the rare earth elements in the glass material of the spacer as described above, the mechanical strength of the spacer is increased and the thickness of the spacer can be further reduced. It is also possible to reduce the number of the spacers, thereby making it promising to realize a flat panel display device having a large screen.

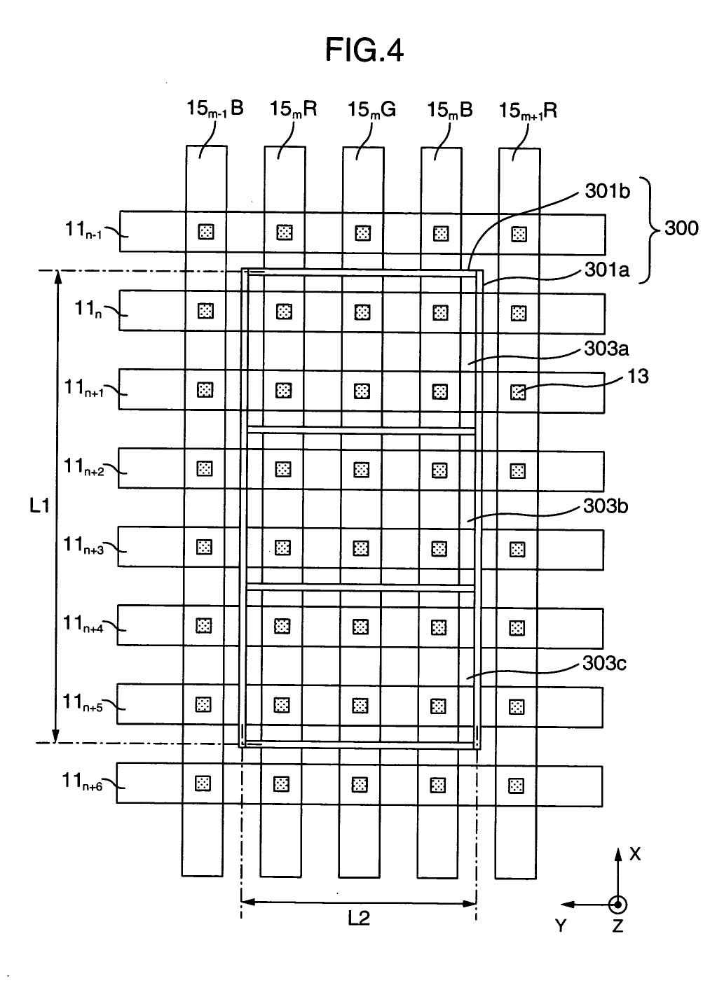

The arrangement of the self-standing spacer 300 formed in the aforementioned manner according to an embodiment of the invention is shown in FIG. 4. The self-standing spacer 300 has a size of about 30×20 mm, and therefore several hundreds of electron emitters are arranged within the spacer area. To facilitate the understanding, however, an explanation will be given on the assumption that there exist 18 electron emitters. Also, it is assumed that only one self-standing spacer is arranged in the area shown in FIG. 4. For the whole of the flat panel display device, however, a plurality of self-standing spacers are arranged between the display-side substrate and the back-side substrate. As shown in FIG. 4, the self-standing spacer 300 includes the short-side sheet-form support members 301b arranged in parallel to the bottom electrodes 11 on the passivation film 17 on the top electrode bus lines 15 in each gap between the bottom electrodes 11. The long-side sheet-form support members 301a, on the other hand, are arranged on the passivation film 17 on the bottom electrodes 11 in the gap between the top electrode bus lines in parallel to the top electrode bus lines 15. The self-standing spacer 300 according to the invention is divided into three areas (303a, 303b, 303c) by the short-side sheet-form support members 301b as apparent from FIGS. 1 and 4. In each of the areas thus divided, each pixel is displayed with three color light of R, G, B, and therefore, there are a total of 6 electron emitters including two sets of three electron emitters of R, G, B.

As described above, in each of one or more rectangular areas (303a, 303b, 303c in FIGS. 1 and 4) of the self-standing spacer divided by the sheet-form support members, one side of each rectangle (length L2 of the area 301b in FIG. 4) parallel to the direction of arrangement of each set of R, G, B color sub-pixels making up one pixel is preferably an integer multiple of the pixel pitch in view of the fact that each pixel is configured of one set of three R, G, B color sub-pixels.

In FIG. 4, the self-standing spacer 300 has the short-side sheet-form support members 301b arranged in parallel to the bottom electrodes 11 and the long-side sheet-form support members 301a in parallel to the top electrode bus lines 15. Nevertheless, the invention is not limited to this arrangement, but as long as one side of each rectangle parallel to the direction of arrangement of each set of R, G, B color sub-pixels making up one pixel is an integer multiple of the pixel pitch, it is apparent that the short-side sheet-form support members 301b may be arranged in parallel to the top electrode bus lines 15 and the long-side sheet-form support members 301a in parallel to the bottom electrodes 11 with equal effect.

Also, in FIGS. 1 and 4, the spaces (303a, 303b, 303c) each having a rectangular area defined by the wall surfaces of the sheet-form support members are equal to each other. Nevertheless, the invention is not limited to this configuration, but it is apparent that assuming that three electron emitters corresponding to a set of R, G, B color sub-pixels make up one unit, the invention is effectively applicable as long as the electron emitters in the number of at least N integer multiples of the unit pixel are existent in each rectangular area, where N is an integer of 1 or more.

The self-standing spacer shown in FIG. 1 is of ladder type. The invention is not limited to this configuration, but as shown in FIG. 17, for example, it is apparent that the invention is equally effectively applicable also to a cellular array in the shape of two sets of spacers of FIG. 1 combined. In FIG. 17, the self-standing spacer 300′ configures a self-standing support structure having a plurality of spaces 303′a to 303′f defined by the wall surfaces of the sheet-form support members 301′a, 301′b assembled. As in the case of FIG. 1, each of the spaces 303 divided into one or more areas by the sheet-form support members is rectangular in shape. One side of each rectangle parallel to the direction of arrangement of each set of R, G, B color sub-pixels making up one pixel in each of these rectangular areas is preferably an integer multiple of the pixel pitch in view of the fact that one pixel is configured of one set of R, G, B color sub-pixels.

The self-standing spacer described above can be preferably shared by at least two types of flat panel display devices of a plurality of sizes including 32 inches and 36 inches, for example. For this purpose, the length of each side of the self-standing spacer is desirably a least common multiple of the pitches at which the electron emitters are arranged in these display devices or an integer multiple of the particular least common multiple. Specifically, to secure a space shared by the flat panel display devices of 32 inches and 36 inches, for example, assume that the pixel pitch for the 32-inch display device is 0.84 mm and the pixel pitch for the 36-inch display device is 0.93 mm. Then, the least common multiple is 78.12 mm, so that the length of each side of the self-standing spacer is set to 78.12 mm or an integer multiple thereof. Since the self-standing spacer is arranged on the center lines of the black matrices, however, the center line of the thickness of each sheet-form support member is set to the center line of the corresponding black matrix, in which case the length of each side of the self-standing spacer is equivalent to the apparent length of the particular side less the thickness of the sheet-form support member involved. Also, the relative positions and the number of the partitioning wall structures of the support members arranged in the vacuum space of the display device can be determined based on the relation with the thickness of the front panel and the back panel.

The spacer according to the invention described above is self-standing. Therefore, the self-standing spacer 300 can be mounted with comparative ease by a manipulator with an image display on the back-side substrate 10 formed with the electron emitters of the self-standing spacer 300, with reference to alignment marks preformed on the back-side substrate 10 using the micromachine. In the process, to facilitate the image recognition of the self-standing spacer 300, the sheet-form support members of the self-standing spacer 300 are desirably milk white or colored otherwise rather than transparent. By so doing, the image is easy to recognize and can be easily picked up with the manipulator while watching the image display for an improved working efficiency.

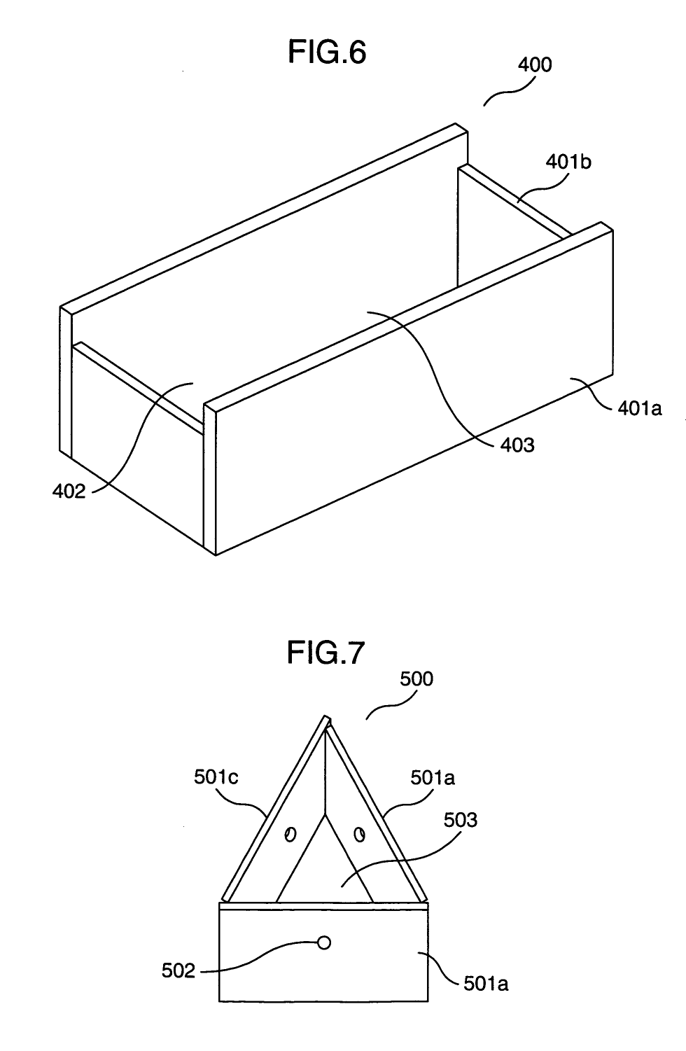

FIG. 6 shows a self-standing spacer according to a second embodiment of the invention. In FIG. 6, the self-standing spacer 400 includes two sheet-form support members 401a and less tall two sheet-form support members 401b. The main difference of this embodiment from the aforementioned first embodiment lies in that the exhaust holes 302 shown in FIG. 1 are eliminated. The provision of the height difference between the sheet-form support members 401a and 401b makes it possible to exhaust the gas from the internal space 403 of the self-standing spacer 400 through an opening 402 formed on the side of each of the sheet-form support members 401b during the pressure reducing step after mounting the spacer on the flat panel display device. This leads to the advantage that the holes for reducing the pressure by exhausting the gas can be done without while maintaining the function of the self-standing spacer.

FIG. 7 shows a self-standing spacer according to a third embodiment of the invention. In FIG. 7, the self-standing spacer 500 includes sheet-form support members 501a, 501b and 501c. The area of the space 503 defined by these tabular members 501a, 501b, 501c is triangular but not rectangular unlike the self-standing spacers shown in FIGS. 1 and 6. This constitutes the feature of this embodiment. Numeral 502 designates holes for reducing the pressure by exhaustion.

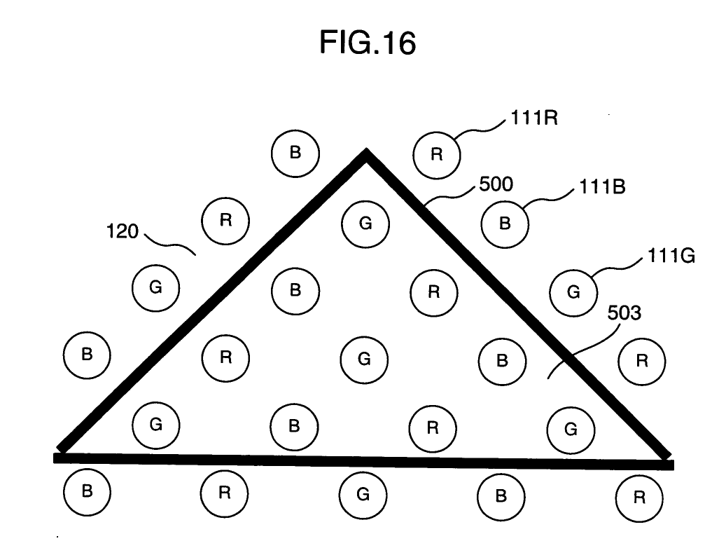

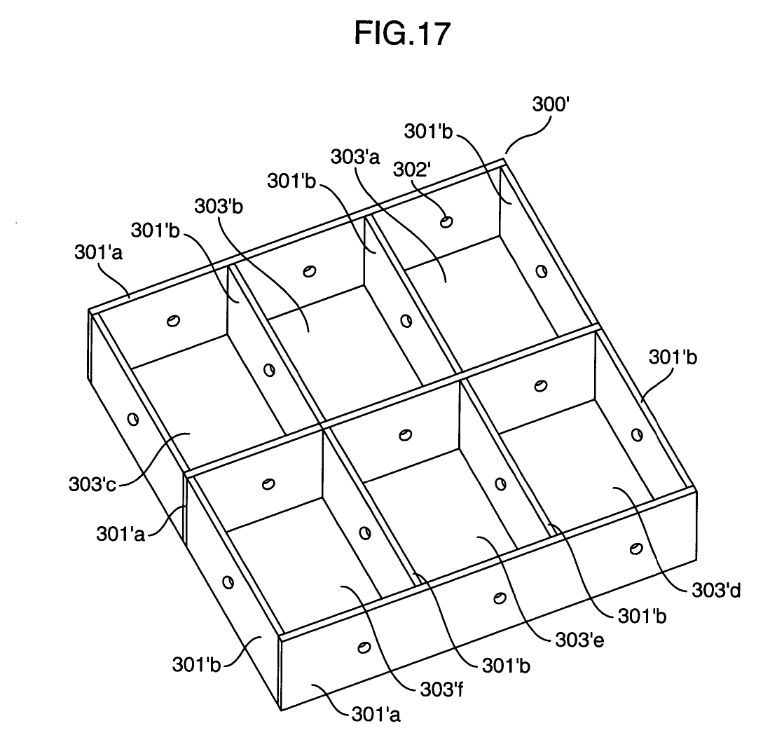

The self-standing spacers according to the embodiments described above correspond to the stripes of the phosphor elements shown in FIGS. 5 and 13 and are arranged within the width of the black matrices. The third embodiment, in contrast, corresponds to a case in which the R, G, B phosphor elements are arranged in delta form. FIG. 16 shows the relative positions of the self-standing spacer 500 and the phosphor elements arranged in delta form. In FIG. 16, at least a set of the phosphor elements 111R, 111G, 111B of R, G, B color sub-pixels is included in the triangular area of the space 503 defined by the self-standing spacer 500. The sheet-form support members making up the self-standing spacer 500 are arranged within the area of the black matrices 120 filling up the gaps of the color sub-pixels phosphor elements in such a manner as not to block the electron beam (not shown) from the back-side substrate.

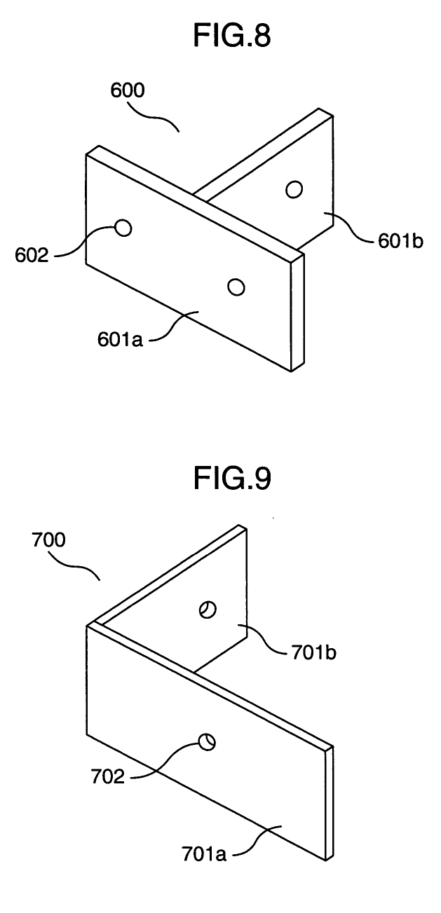

FIGS. 8 and 9 each show a self-standing spacer, though not defined by the sheet-form support members, according to an embodiment. FIG. 8 shows a T-shaped self-standing spacer 600 in which a sheet-form support member 601a and a sheet-form support member 601b are combined with each other in the shape of T. FIG. 9 shows an L-shaped self-standing spacer 700 in which a sheet-form support member 701a and a sheet-form support member 701b are combined with each other in the shape of L. Numerals 602, 702 designate holes.

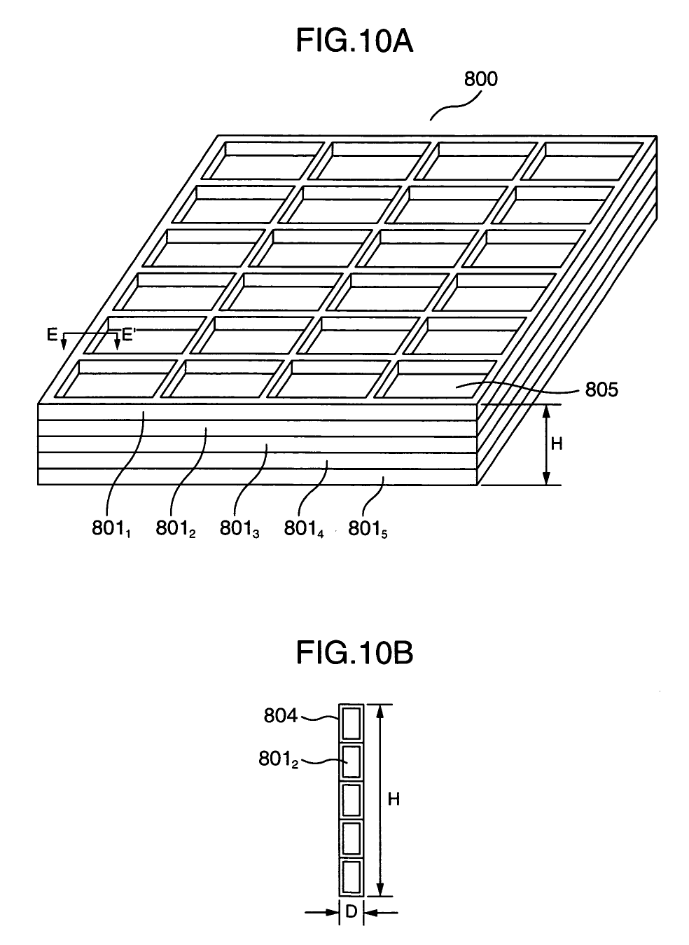

The aforementioned spacers are formed of a glass material. On the other hand, an embodiment in which the spacer is formed of a metal material will be explained with reference to FIGS. 10A and 10B. FIGS. 10A and 10B show a part of a metal spacer according to this embodiment of the invention. In FIGS. 10A and 10B, a metal spacer 800 is configured of a stack of thin Fe—Ni metal sheets 801ᵢ (i attached to discriminate each of the metal sheets stacked) easy to etch. The metal sheet 801ᵢ is formed with a multiplicity of rectangular holes 805 by etching as shown in FIG. 10A. Each hole 805 has a partitioning wall of about 400 μm. A thin insulating layer 804 is formed on the metal sheet 801ᵢ formed with the holes by etching. FIG. 10B shows a sectional view taken in line E-E′ in FIG. 10A. The insulating layer 804 shown in FIG. 10B is coated with polysilazane which is a liquid precursor of the glass, for example, and makes up an insulating layer (with the surface resistance of not less than 10¹³ Ω/□) of a silica film baked at high temperatures of not lower than 120° C. in the atmosphere. A plurality of the metal sheets thus obtained are stacked to the height H of the spacer to hold a predetermined interval between the display-side substrate and the back-side substrate. In the case where the thickness of each metal sheet is 0.5 mm, for example, a stack of five metal sheets constitutes a spacer 2.5 mm tall. The self-standing spacer 800, unlike the spacer shown in FIG. 1, is not formed with exhaust holes. No problem is posed, however, by employing a known fabrication method for assembling the display-side substrate, the back-side substrate and the spacer after exhausting the gas in the vacuum device.

With the self-standing spacers configured by assembling the sheet-form support members described above, a single spacer cannot provide the size of the display screen. According to this method of etching metal sheets, on the other hand, a spacer of the display screen size can be formed simply by etching metal sheets of the display screen size. This method, therefore, is suitable for mass production.

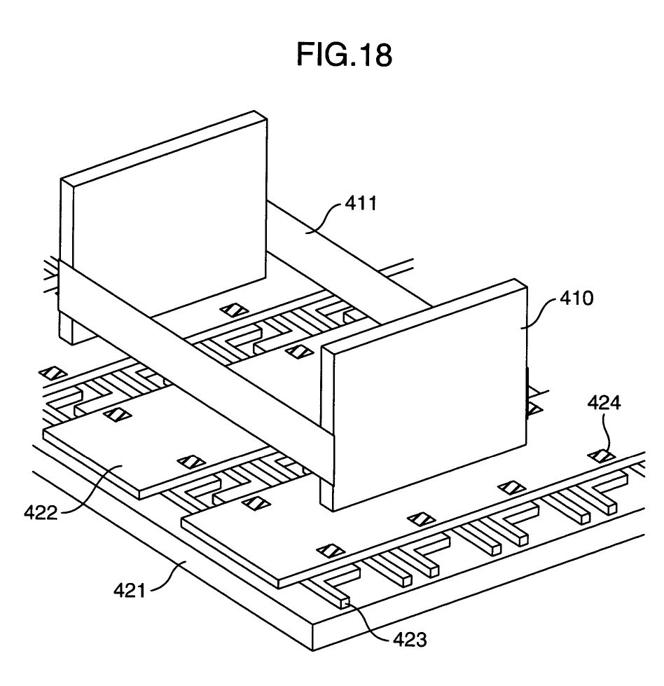

With reference to FIG. 18, a self-standing spacer according to still another embodiment of the invention will be explained. FIG. 18 is a perspective view of a back-side substrate with a spacer. The back-side substrate includes a glass substrate 421, scanning electrodes 422, signal electrodes 423 and electron emitters 424.

To configure a FED requires a front (display-side) substrate (not shown) formed with an anode and phosphor elements and arranged in opposed relation to the back-side substrate. In order to display a uniform image free of irregularities, a uniform gap may be maintained between the back-side substrate and the front substrate by forming a spacer 410 about 2 mm tall, for example. This spacer 410 is arranged in an area containing no pixels to prevent the electrons jumped out of the back-side substrate from proceeding along a predetermined path. In the case where the pixels are arranged at intervals of about 0.3 mm, the spacer 410 is about 0.05 to 0.1 mm thick and about 2 mm tall. In order to assemble this thin, tall spacer 410 upright, as shown in FIG. 18, two spacers 410 are coupled to each other in advance with support members 411 as thick as or less thick than the spacers 410 to form a box conveniently.

In spite of this, a part of the electrons may bombard the spacers and the charge may be stored in the spacers. In order to release this charge, the spacers with a slightly conductive surface are arranged on the scanning electrodes 422. In the process, the scanning electrode pattern and the pixel connection pattern are configured so as to enable two pixel rows to be selected with one scanning electrode 422 (i.e. two pixel rows connected to one scanning electrode 422 are selected at the same time by applying a signal to the scanning electrode). In this way, the width of each scanning electrode can be increased, and thick spacers can be assembled on the scanning electrodes. As a result, the spacer strength can be secured, and in addition, the spacers and the scanning electrodes can be matched in position with a margin of accuracy.

In assembling a FED, the back-side substrate and the front substrate are bonded by applying a force thereto. The spacer inserted between the two substrates, therefore, is slightly forced into the base scanning electrode. For this reason, the scanning electrode 422 is formed with a comparative thickness to function as a cushion. In that case, the support members 411 are mounted while being raised from the lower end of the spacers 410 by an amount approximate to the thickness of the scanning electrodes not to damage the wiring pattern. Also, in order to avoid the effect of the stored charge, the part of the support member 411 nearer to the front substrate is set in a position lower than the spacers 410. Generally, to attain the full color with the red, green and blue pixels arranged in stripes vertically on the screen, the FED is often so constructed that the pixels are liable to be arranged narrowly in horizontal direction and widely in vertical direction. As a result, the electrons from the electron emitters 424 are affected by the charge stored in the spacers, etc. existent between the horizontal pixels and may not enter the phosphor elements smoothly. Taking the small horizontal intervals of the pixels into account, therefore, the thickness of the support members 411 arranged horizontally between the pixels is preferably smaller than the thickness of the spacers 410.

It will thus be understood from the foregoing description that according to this invention, the spacer can be easily mounted on the substrates. Also, the spacer formed in the shape of a ladder or cells having a plurality of rectangular spaces is increased in strength.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A display device comprising:
a first substrate having a plurality of electron emitters arranged in a matrix;
a second substrate arranged in opposed relation to said first substrate, said second substrate including a phosphor pattern for emitting light by receiving the electron beam released from said electron emitters and a metal thin film for accelerating said electron beam; and
at least a spacer arranged between said first substrate and said second substrate for supporting said first substrate and said second substrate;
wherein said spacer includes a plurality of first sheet-form support members extending in a predetermined direction and a plurality of second sheet-form support members extending in a direction different from said predetermined direction, said first sheet-form support members and said second sheet-form support members being coupled to each other thereby to form spaces each containing at least one of said electron emitters.

2. A display device according to claim 1,
wherein said first sheet-form support members and said second sheet-form support members are arranged at right angles to each other, and
wherein at least that section of at least one of the spaces formed by said first sheet-form support members and said second sheet-form support members which is parallel to selected one of said first substrate and said second substrate is rectangular.

3. A display device according to claim 1,
wherein that section of at least one of the spaces formed by said first sheet-form support members and said second sheet-form support members which is parallel to selected one of said first substrate and said second substrate is triangular.

4. A display device comprising:
a first substrate having a plurality of electron emitters arranged in a matrix;
a second substrate arranged in opposed relation to said first substrate, said second substrate including a phosphor pattern for emitting light by receiving the electron beam released from said electron emitters and a metal thin film for accelerating said electron beam; and
at least a spacer arranged between said first substrate and said second substrate for supporting said first substrate and said second substrate;
wherein said spacer includes a plurality of first sheet-form support members and a plurality of second sheet-form support members extending in a direction perpendicular to said first sheet-form support members, said first sheet-form support members and said second sheet-form support members being combined with each other thereby to form a plurality of rectangular spaces each having a section parallel to selected one of said first substrate and said second substrate.

5. A display device according to claim 4,
wherein at least one of said electron emitters is arranged in each of said spaces formed by said first sheet-form support members and said second sheet-form support members.

6. A display device according to claim 4,
wherein at least one of units each including three of said electron emitters is arranged in each of said spaces formed by said first sheet-form support members and said second sheet-form support members, and said each unit corresponds to a set of red (R), green (G) and blue (B) color sub-pixels.

7. A display device according to claim 4,
wherein said first sheet-form support members and said second sheet-form support members are coupled integrally with each other by a dielectric material adapted to be molten at temperatures.

8. A display device according to claim 4,
wherein said first sheet-form support members and said second sheet-form support members are coupled integrally with each other fixedly by a silica film obtained by using an inorganic polymer containing a basic unit of a nitrogen-silicon combination as a starting material.

9. A display device according to claim 4,
wherein said first sheet-form support members and said second sheet-form support members each include at least one through hole having a diameter of 10 to 50 μm.

10. A display device according to claim 4,
wherein said first sheet-form support members and said second sheet-form support members are colored in selected one of milk white and other colors.

11. A display device according to claim 4,
wherein the length of one side of said spacer is selected one of a least common multiple of the pitches of arrangement of at least two of said electron emitters and an integer multiple of said least common multiple.

12. A display device according to claim 4,
wherein the aspect ratio H/D of said spacer separating said first substrate and said second substrate from each other is in the range of 20:1 to 100:1, where H is the height of said spacer, and D is the thickness of selected one of the bottom portion and the uppermost portion of said spacer.

13. A display device according to claim 4,
wherein said spacer is formed of glass containing as a main component SiO₂ having a strain point of not lower than 400° C.

14. A display device according to claim 13,
wherein said glass constituting the material of said spacer is selected one of aluminosilicate glass and alumino borosilicate glass containing at least one rare earth element selected from Sc, Y, Pr, Nd, Pm, Eu, Gd, Tb, Dy, Ho, Er, Tm, Yb and Lu.

15. A display device according to claim 13,
wherein said glass constituting the material of said spacer is at least configured of, by oxide weight percent, 40 to 80% of SiO₂, 0 to 20% of B₂O₃, 0 to 20% of Al₂O₃, 0 to 20% of alkali metal oxide R₂O, 0 to 20% of alkali earth metal oxide R′O and 0 to 20% of rare earth element oxide Ln₂O₃.

16. A display device according to claim 13,
wherein said glass constituting the material of said spacer is at least configured of, by oxide weight percent, 50 to 80% of SiO₂, 5 to 12% of B₂O₃, 1 to 17% of Al₂O₃, 7 to 15% of alkali metal oxide R₂O and 5 to 20% of rare earth element oxide Ln₂O₃.

17. A display device according to claim 13,
wherein the surface of the glass constituting the material of said spacer is formed with a conductive film having a resistance value of 10⁵ to 10¹² Ω/□.

18. A display device according to claim 17,
wherein said conductive film is formed of at least selected one of oxides of tin, titanium and indium.

19. A display device according to claim 17,
wherein said conductive film is formed by at least selected one of the methods including the sol-gel process, the sputtering method and the CVD process.

20. A display device according to claim 13,
wherein a conductive material is dispersed in the glass constituting the material of said spacer in such an amount that the surface resistance of the glass is 10⁵ to 10¹² Ω/□.

21. A display device according to claim 20,
wherein said conductive material is conductive particulates.

22. A display device according to claim 20,
wherein said conductive particulates are selected one of a metal and a precious metal.

23. A display device according to claim 20,
wherein said conductive particulates include at least selected one of Pt, Ag, Au and Cr.

24. A display device according to claim 20,
wherein said conductive particulates are metal ions.

25. A display device according to claim 24,
wherein said metal ions are transition metal ions.

26. A display device according to claim 20,
wherein said metal ions are at least selected one of Nb, Ti, Sn, Co, Fe and V.

27. A display device according to claim 20,
wherein said conductive particulates are a conductive oxide and composed of a glass base containing 0.1 to 5 weight % of a semiconductor with impurities doped into said conductive oxide.

28. A display device according to claim 24,
wherein said conductive oxide is at least selected one of indium oxide, tin oxide and titanium oxide.

29. A display device according to claim 12,
wherein said spacer is formed of a metal material having the surface thereof formed with an insulating layer having a resistance value of not lower than 10¹³ Ω/□.

30. A display device according to claim 29,
wherein said metal material is a Fe—Ni alloy.

31. A display device according to claim 29,
wherein said insulating layer is formed of at least selected one of a glass material and a mixture of said glass material and a crystalline material.

32. A display device according to claim 29,
wherein said insulating layer is formed by at least selected one of the CVD process and a method of coating the surface of said metal material with a spray and heating and baking the resulting assembly.

33. A display device comprising:
a back electrode including a plurality of scanning electrodes extending in horizontal direction on the screen, a plurality of signal electrodes extending in vertical direction on the screen and a plurality of electron emitters arranged at the crossing points between said plurality of said scanning electrodes and said plurality of said signal electrodes to emit electrons;
a front substrate arranged in opposed relation to said back electrode and including phosphor elements for emitting light by being irradiated with electrons from said electron emitters; and
a plurality of spacers arranged between said back electrode and said front substrate to form spaces between said back electrode and said front substrate;
wherein said plurality of said spacers are arranged on said scanning electrodes, respectively, and each two spacers arranged on two different ones of said scanning electrodes are coupled to each other by support members thereby form a box-type spacer.

34. A display device according to claim 33,
wherein one of said scanning electrodes is connected with two rows of said electron emitters.

35. A display device according to claim 33,
wherein said support member is shorter than the height of said spacer, and the bottom surface of said support member is located at a higher position than the thickness of said scanning electrodes from the bottom surface of said spacer.
